(19) United States
(12) Patent Application Publication
(10) Pub. No.: US 2026/0148530 A1
(43) Pub. Date: May 28, 2026

(54) MACHINE LEARNING METHOD

(71) Applicant: TOYOTA JIDOSHA KABUSHIKI KAISHA, Toyota-shi (JP)

(72) Inventor: Masayuki YAMAZAKI, Yokohama-shi (JP)

(73) Assignee: TOYOTA JIDOSHA KABUSHIKI KAISHA, Toyota-shi (JP)

(21) Appl. No.: 19/325,047

(22) Filed: Sep. 10, 2025

(30) Foreign Application Priority Data
Nov. 26, 2024 (JP) 2024-205814

(51) Int. Cl. G06V 10/774; G06V 10/62

(52) U.S. Cl. CPC G06V 10/774; G06V 10/62

(57) ABSTRACT

An information processing device determines whether an object is present in a captured image based on time-series data of the captured image by performing first determination processing. Next, the information processing device determines whether the object is present in the captured image based on the time-series data by performing second determination processing using a first learning model. The information processing device executes third determination processing of determining whether the object is present in the captured image by using a second learning model, in a case where results related to presence or absence of the object in the first determination processing and the second determination processing are different from each other. Then, the information processing device adds the captured image to the first learning model based on a result of the third determination processing.

### CROSS-REFERENCE TO RELATED APPLICATION

This application claims priority to Japanese Patent Application No. 2024-205814 filed on Nov. 26, 2024. The disclosure of the above-identified application, including the specification, drawings, and claims, is incorporated by reference herein in its entirety.

### BACKGROUND

### 1. Technical Field

The present disclosure relates to a machine learning method executed by an information processing device.

### 2. Description of Related Art

In the related art, a technique used for machine learning is known. For example, according to Japanese Unexamined Patent Application Publication No. 2018-200531 (JP 2018-200531 A), learning is performed by an object recognition method using reference data including a specific identification target. An identification model in which an identification model for a specific identification target is created is used to detect the specific identification target from video data including the specific identification target by using the object recognition method. Training data for the specific identification target is generated.

### SUMMARY

It is desired to improve the technique used for machine learning.

An object of the present disclosure made in view of such circumstances is to improve a technique used for machine learning.

According to an embodiment of the present disclosure, there is provided a machine learning method executed by an information processing device. The machine learning method includes
determining whether an object is present in a captured image based on time-series data of the captured image by performing first determination processing;
determining whether the object is present in the captured image based on the time-series data of the captured image by performing second determination processing using a first learning model;
executing third determination processing of determining whether the object is present in the captured image by using a second learning model, in a case where results related to presence or absence of the object in the first determination processing and the second determination processing are different from each other; and
adding the captured image to the first learning model based on a result of the third determination processing.

According to the embodiment of the present disclosure, the technique used for machine learning is improved.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram showing a schematic configuration of an information processing device according to the present disclosure; and

FIG. 2 is a flowchart showing an operation of the information processing device according to the present disclosure.

### DETAILED DESCRIPTION OF EMBODIMENTS

An embodiment of the present disclosure will be described below.

### Overview of Embodiment

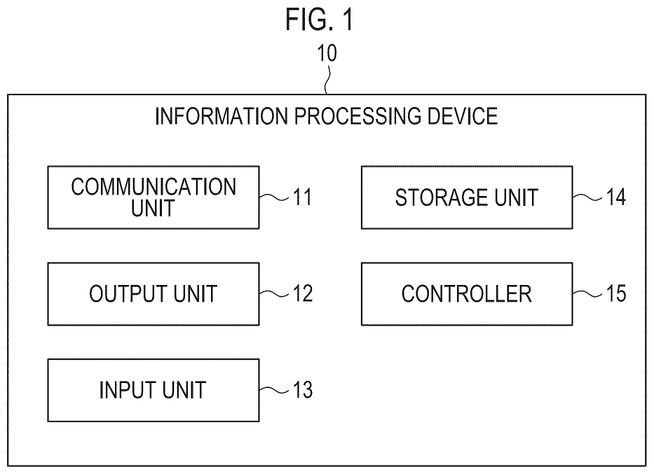

A configuration of the information processing device 10 according to the present embodiment will be described with reference to FIG. 1. The information processing device 10 is, for example, a computer such as a server device, a personal computer (PC), or a smartphone, or a general-purpose or dedicated electronic device. The information processing device 10 is connected to a server that provides any learning model such as a first learning model or a second learning model used in the present embodiment, via a network.

First, an outline of the present embodiment will be described, and details will be described later. The information processing device 10 determines whether an object is present in a captured image based on time-series data of the captured image by performing first determination processing. Next, the information processing device 10 determines whether the object is present in the captured image based on the time-series data by performing second determination processing using a first learning model. In a case where results related to presence or absence of the object in the first determination processing and the second determination processing are different from each other, the information processing device 10 executes third determination processing of determining whether the object is present in the captured image by using a second learning model. Then, the information processing device 10 adds the captured image to the first learning model based on a result of the third determination processing.

An object recognition method using anomaly detection or anomaly estimation requires collection of training data for recognition in advance. However, since the training data related to an abnormality is small, it is difficult to detect anomaly data by using the object recognition method. Therefore, it is a problem how to generate the training data related to the abnormality. On the other hand, according to the present embodiment, the information processing device 10 uses two different determination processing, such as the first determination processing and the second determination processing, for determining the presence or absence of the object in the captured image, and executes the third determination processing in a case where the determination results are different. Then, the information processing device 10 adds the captured image to the first learning model used in the second determination processing based on the result of the third determination processing. Therefore, for example, in a case where it is determined that the object is not present in the captured image only by the second determination processing using the first learning model, an opportunity to generate the training data related to the presence or absence of the object used for the first learning model, such as adding the captured image as training data related to the abnormality in which the object is present, can be improved. In addition, as a result, accuracy of the determination of the presence or absence of the object of the first learning model can be improved. Therefore, according to the present embodiment, the technique used for machine learning is improved in terms of the opportunity to generate the training data related to the presence or absence of the object and the accuracy of the determination of the presence or absence of the object of the first learning model can be improved.

Next, a configuration of the information processing device 10 will be described in detail.

### Configuration of Information Processing Device

The information processing device 10 includes a communication unit 11, an output unit 12, an input unit 13, a storage unit 14, and a controller 15.

The communication unit 11 includes one or more communication interfaces connected to the network. The communication interface corresponds to, for example, a mobile communication standard, such as a 4th generation (4G) or a 5th generation (5G), but the present disclosure is not limited thereto. The communication unit 11 receives information used for the operation of the information processing device 10 and transmits information obtained by the operation of the information processing device 10. In addition, in the present embodiment, the communication unit 11 enables the information processing device 10 to perform communication with, for example, a terminal device or a server that provides time-series data of a captured image for determining the presence or absence of an object, via the network. In addition, in a case where the information processing device 10 uses a learning model present on another server, the communication unit 11 enables the information processing device 10 to perform communication with the server via the network.

The output unit 12 includes one or more output devices that output information. The output device is, for example, a display that outputs information in a video or a speaker that outputs information in a sound, but the present disclosure is not limited thereto. Alternatively, the output unit 12 may include an interface for connecting an external output device.

The input unit 13 includes one or more input devices that detect an input operation by a user. The input device is, for example, a physical key, a capacitive key, a mouse, a touch panel, a touch screen integrally provided with a display of the output unit 12, or a microphone, but the present disclosure is not limited thereto. Alternatively, the input unit 13 may include an interface for connecting an external input device.

The storage unit 14 includes one or more memories. The memory is, for example, a semiconductor memory, a magnetic memory, an optical memory, or the like, but is not limited thereto. Each memory included in the storage unit 14 may function as, for example, a main storage device, an auxiliary storage device, or a cache memory. The storage unit 14 stores any information used for an operation of the information processing device 10. For example, the storage unit 14 may store a system program, an application program, or embedded software. For example, the information stored in the storage unit 14 may be capable of updating with information acquired from the network via, for example, the communication unit 11. In addition, the storage unit 14 may store normal data and anomaly data used for the first learning model as learning data. In addition, the storage unit 14 may store the first learning model and/or the second learning model.

The controller 15 includes at least one processor, a programmable circuit such as at least one field-programmable gate array (FPGA), a dedicated circuit such as at least one application specific integrated circuit (ASIC), or any combination thereof. The processor is a general-purpose processor, such as a central processing unit (CPU) or a graphics processing unit (GPU), or a dedicated processor specialized for specific processing. The controller 15 executes processing related to an operation of the information processing device 10 while controlling each unit of the information processing device 10.

### Operation Procedure of Information Processing Device

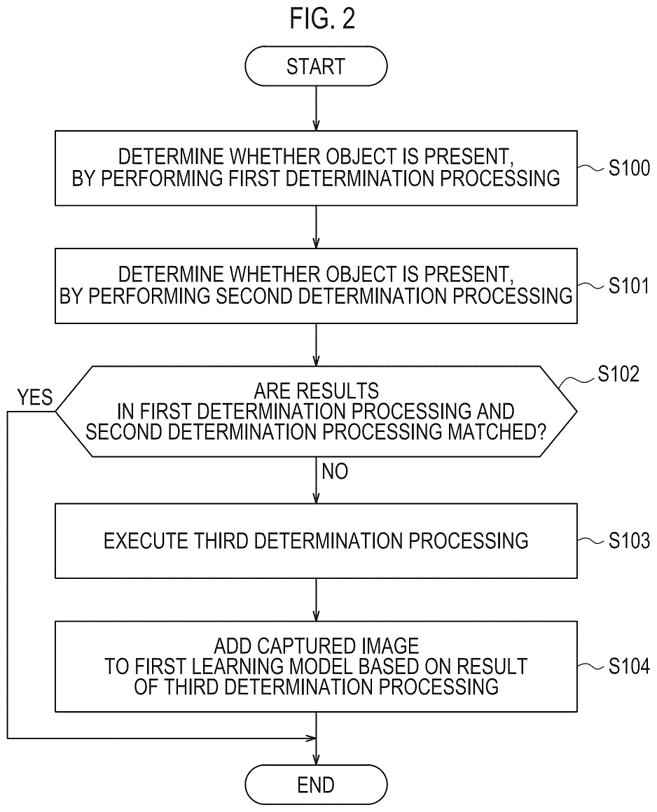

The operation of the information processing device 10 according to the present embodiment will be described with reference to FIG. 2.

S100: The controller 15 of the information processing device 10 determines whether the object is present in the captured image based on the time-series data of the captured image by performing the first determination processing.

Specifically, for example, in a case where the user inputs the time-series data of the captured image by using the input unit 13, the controller 15 estimates a depth of each captured image included in the time-series data by using depth estimation. Next, the controller 15 calculates a difference in depth of each captured image in time series, and operates on each difference. Then, the controller 15 determines the presence or absence of the object by whether a magnitude of the difference is equal to or greater than a first threshold value. In a case where the magnitude of the difference is equal to or greater than the first threshold value, the controller 15 determines that the object is present in the captured image. In a case where the magnitude of the difference is less than the first threshold value, the controller 15 determines that the object is not present in the captured image. It should be noted that the time-series data of the captured image may be directly received via the communication unit 11 from a vehicle that is traveling on a road, for example, may use the time-series data stored in the storage unit 14, or may be received from another server. In this way, the time-series data of the acquired captured image can be used by any method. The first threshold value is any value at which there is a high possibility that the object is present in the captured image. The first threshold value may be changeable. In addition, any learning model may be used for the first determination processing.

S101: The controller 15 determines whether the object is present in the captured image based on the time-series data by performing the second determination processing using the first learning model.

Specifically, the controller 15 inputs the time-series data of the captured image acquired in S101 to an anomaly estimation model that is the first learning model. Next, the controller 15 acquires a result of an estimated depth of each captured image included in the time-series data output from the first learning model. Next, the controller 15 calculates a difference in depth of each captured image in time series, and operates on each difference. Then, the controller 15 determines the presence or absence of the object by determining whether a magnitude of the difference is equal to or greater than a second threshold value. In a case where the magnitude of the difference is equal to or greater than the second threshold value, the controller 15 determines that the object is present in the captured image. In a case where the magnitude of the difference is less than the second threshold value, the controller 15 determines that the object is not present in the captured image. It should be noted that the second threshold value is any value at which there is a high possibility that the object is present in the captured image. The second threshold value may be changeable. In addition, the output from the first learning model is not limited to the result of the depth, and may be any output for determining the presence or absence of the object, such as information indicating a region where the object is estimated to be present on the captured image. The first learning model may be an anomaly detection model or any other learning model.

S102: The controller 15 determines whether the results related to the presence or absence of the object in the first determination processing and the second determination processing match.

In a case where the results match (S102—Yes), the controller 15 ends the process as being correct in the determination of the first learning model. In a case where the results are different (S102—No), the process proceeds to S103.

S103: In a case where the results related to the presence or absence of the object in the first determination processing and the second determination processing are different from each other (S102—No), the controller 15 executes the third determination processing of determining whether the object is present in the captured image by using the second learning model.

Specifically, for example, in a case where the second learning model is a large language model (LLM), the controller 15 inputs the captured image to the second learning model as an input and inputs a prompt for inquiring whether the captured image is the object. It should be noted that the second learning model may be any learning model different from the first learning model.

S104: The controller 15 adds the captured image to the first learning model based on the result of the third determination processing.

For example, in a case where it is determined that the object is present in S100, it is determined that the object is not present in S101, and it is determined that the object is present in S103, the controller 15 may add the captured image to the first learning model as the training data of the information related to the presence of the object. This is because the determination of the first learning model is incorrect and there is a high possibility that the object is present in the captured image. In addition, in a case where it is determined that the object is not present in S100, it is determined that the object is present in S101, and it is determined that the object is not present in S103, the captured image may be added to the first learning model as training data of information related to the absence of the object. This is because the determination of the first learning model is incorrect and there is a high possibility that the object is not present in the captured image. In other cases, the controller 15 may end the processing. This is because there is a high possibility that the determination of the first learning model is correct.

Although the present disclosure has been described with reference to drawings and embodiments, it should be noted that various variations and modifications may be made by those skilled in the art based on the disclosure. Therefore, it should be noted that the variations and modifications fall within the scope of the present disclosure. For example, functions included in each component or each step can be rearranged so as not to be logically inconsistent, and multiple components or steps can be combined together or separated.

For example, in the above-described embodiment, an embodiment in which the configuration and operation of the information processing device 10 may be distributed to a plurality of computers capable of communicating with each other is also possible. For example, the information processing device 10 may be configured by the computers.

In addition, for example, in the embodiment described above, in a case where a plurality of objects are detected from the captured image in the first determination processing and the second determination processing, the controller 15 may crop each part of the objects detected from the captured image. Then, the controller 15 may execute the third determination processing of determining the presence or absence of the object in each of the parts cropped from the captured images having different results in a case where any of the results related to the presence or absence of the objects in the first determination processing and the second determination processing is different.

Specifically, the controller 15 divides the captured image into a plurality of regions in each of S101 and S102, and crops each region that is equal to or greater than the first threshold value or equal to or greater than the second threshold value in each region. Next, the controller 15 determines whether all the regions cropped in each of S101 and S102 match. In a case where the cropped regions do not match, the controller 15 determines that any of the results related to the presence or absence of the objects in the first determination processing and the second determination processing is different. In this case, the controller 15 executes S103 for each of the cropped regions that do not match. Then, the controller 15 may add the captured image to the first learning model based on a summary of the results of S103 in each of the cropped regions that do not match. For example, the controller 15 may add the captured image to the first learning model only in a case where all the determinations of the presence or absence of the object in S101 and S103 in each of the cropped regions that do not match are matched. Alternatively, the controller 15 may add each of the cropped regions to the first learning model based on the result of S103 in each of the cropped regions that do not match.

For example, an embodiment in which a general-purpose computer functions as the information processing device 10 according to the above-described embodiment is also possible. Specifically, a program describing processing contents that realize each function of the information processing device 10 according to the above-described embodiment is stored in a memory of the general-purpose computer, and the program is read and executed by a processor. Therefore, the present disclosure can also be realized as a program that can be executed by a processor or a non-transitory computer-readable medium that stores the program.

What is claimed is:

1. A machine learning method executed by an information processing device, the machine learning method comprising:
determining whether an object is present in a captured image based on time-series data of the captured image by performing first determination processing;
determining whether the object is present in the captured image based on the time-series data by performing second determination processing using a first learning model;
executing third determination processing of determining whether the object is present in the captured image by using a second learning model, in a case where results related to presence or absence of the object in the first determination processing and the second determination processing are different from each other; and
adding the captured image to the first learning model based on a result of the third determination processing.

2. The machine learning method according to claim 1, wherein the information processing device adds, in a case where determination is made that the object is present in the first determination processing, determination is made that the object is not present in the second determination processing, and determination is made that the object is present in the third determination processing, the captured image to the first learning model as training data of information related to presence of the object.

3. The machine learning method according to claim 1, wherein the information processing device adds, in a case where determination is made that the object is not present in the first determination processing, determination is made that the object is present in the second determination processing, and determination is made that the object is not present in the third determination processing, the captured image to the first learning model as training data of information related to absence of the object.

4. The machine learning method according to claim 1, further comprising cropping, in a case where a plurality of objects is detected from the captured image in the first determination processing and the second determination processing, respective parts of the objects detected from the captured image,
wherein the information processing device executes the third determination processing of determining whether the object is present in each of the parts cropped from the captured image having different results, in a case where any of results related to presence or absence of the objects in the first determination processing and the second determination processing is different.

5. The machine learning method according to claim 1, wherein the first determination processing is performed using depth estimation.
